(19) United States
(12) Patent Application Publication
(10) Pub. No.: US 2013/0119303 A1
(43) Pub. Date: May 16, 2013

(54) MEDIUM FOR IMPROVING THE HEAT TRANSFER IN STEAM GENERATING PLANTS

(71) Applicants: Wolfgang Hater, Kaarst (DE); Christian Zum Kolk, Erkrath (DE); Andre De Bache, Muehlheim (DE)

(72) Inventors: Wolfgang Hater, Kaarst (DE); Christian Zum Kolk, Erkrath (DE); Andre De Bache, Muehlheim (DE)

(73) Assignee: BK Giulini GmbH, Ludwigshafen (DE)

(21) Appl. No.: 13/698,527

(22) PCT Filed: Sep. 1, 2010
(86) PCT No.: PCT/EP2010/005364

§ 371 Date: Jan. 30, 2013

(30) Foreign Application Priority Data
May 18, 2010 (DE) 10 2010 020 717.9

(51) Int. Cl. C09K 5/00

(52) U.S. Cl. CPC C09K 5/00
USPC 252/77

(57) ABSTRACT

The present invention relates to a medium in the form of an aqueous mixture for improving the heat transfer coefficient and use thereof in power plant technology, in particular in steam generating plants. The medium contains at least one film-forming amine (component a) with the general formula: R—(NH—(CH2)m)n—NH2/, where R is an aliphatic hydrocarbon radical with a chain length between 12 and 22 and m is an integral number between 1 and 8 and n is an integral number between 0 and 7, contained in amounts up to 15%.

The present invention relates to a medium in the form of an aqueous mixture for improving the heat transfer coefficient and the use thereof in power plant technology, in particular in steam generating plants.

Water is always required for operating steam generating plants. Wherever water is used, either in the form of cooling water or as a medium for the heat transfer, the water must be treated with water conditioning agents. Process water for operating steam generating plants can always contain salts, mainly alkali and alkaline earth metal cations in the dissolved form, e.g. as hydrogen carbonate, which can then be deposited as coatings in the form of scale on the surfaces of the boilers and the tubes of the heat transfer systems, owing to the increased concentration in the evaporating water. As a result, the heat transfer in the systems is hindered considerably and overheating may occur. Added to this is the danger of corrosion of the tubes and the boiler materials.

For economic and safety reasons, the operators of said plants or systems are obligated to avoid and/or prevent these precipitations and corrosion by using a corresponding water conditioning concept, so as not to endanger the functions of the plants.

Owing to the complete removal of the mineral salts from the water, for example via ion exchangers or reverse osmosis, it is possible in an economically acceptable manner to prevent the scale forming caused by the precipitating out of non-soluble salts such as calcium carbonate.

A further method for avoiding corrosion is the alkalization of the water-steam circuit, e.g. through adding alkalizing conditioning agents which prevent iron from being dissolved out of the apparatus components at high temperatures by increasing the pH values. These agents can be inorganic compounds such as phosphates, but also organic conditioning agents.

The use of film-forming amines for inhibiting corrosion has been described multiple times in the prior art.

Thus, the EP 0 134 365 B1 discloses a medium for inhibiting corrosion in steam generating plants and for conditioning boiler feed water in power plants, wherein this medium is composed of a mixture of aliphatic polyamines with 12 to 22 C atoms in the aliphatic radical, of an alkalizing amine such as cyclohexylamine, and of an amine ethanol.

The EP 0 184 558 B1 describes a method for preventing the depositing of scale by adding a synergistically acting mixture of polymer salts, ethylenically unsaturated carbonic acids, and aliphatic polyamines to the water to be treated.

The EP 0 463 714 A1 describes a ternary composition of dihydroxyacetone, catalytic amounts of hydroquinone and volatile amines for eliminating oxygen from the feed water and to prevent corrosion. So-called “film-forming amines” can also be contained in this composition.

The EP 0774 017 B1 describes a corrosion inhibitor of a polysulfonic acid which additionally contains polyamines, in particular a dispersing agent in the form of oxyalkylated polyamines.

In addition to the corrosion and scale forming, the secure heat transfer during the boiling of water in steam generators is a very important problem that continues to be relevant. A particular problem is the possible start of the Burnout I effect or condition, meaning a changeover of the nucleate boiling to a film boiling as a result of an excessively high number of steam bubble forming centers, but also a Burnout III condition, meaning a boiling crisis resulting from the suppression of steam bubble forming centers which can be activated. A negative influence was expected from organic as well as inorganic conditioning agents. The problem of increasing the safety during the heat transfer has so far not been solved in a satisfactory manner, especially not with the aid of the medium known from the aforementioned prior art which did not deal with this problem.

Despite the fact that organic conditioning agents which also contain film-forming amines for fighting corrosion and to prevent the scale forming have long been known, the effect of amines in the steam cycle of improving the heat transfer was not suspected, even though experiments relating thereto were conducted in 2003 already.

According to the publication VBG Power Tech, 9/2003 entitled: “SIND AMINE EINE ALTERNATIVE ZU HERKOEMMLICHEN KON-DITIONIERUNGSMITTELN FUER WASSER-DAMPF-KREISLÄUFE?” [Do Amines Represent An Alternative To Traditional Conditioning Medium For Water-Steam-Cycles?] by Professor Steinbrecht, it was determined in a model apparatus that neither Na₃PO₄ nor the amines had too negatively an effect on the heat transfer, especially in the technical area of interest relating to heat flux densities <500 kW/m², realized in large-scale water boilers. In this case, the medium examined are sold under the brand names of “Helamin” and “Odacon” and are organic amines and/or contain organic amines.

In this connection, the model apparatus developed by Professor Steinbrecht appeared to be suitable to also examine the mixture, developed according to our invention, for its suitability and effect in steam boilers during the heat transfer.

Owing to the similar structure of the medium, the expectation was that the use of the new agent would not result in noticeable differences as compared to the known products.

However, the researchers were surprised to discover during the experiments that the use of the inventive agent, which is an aqueous mixture containing among other things several film-forming amines, resulted in a considerable improvement of the heat transfer, a result which could be quantified by measuring the heat transfer coefficient on the side of the water.

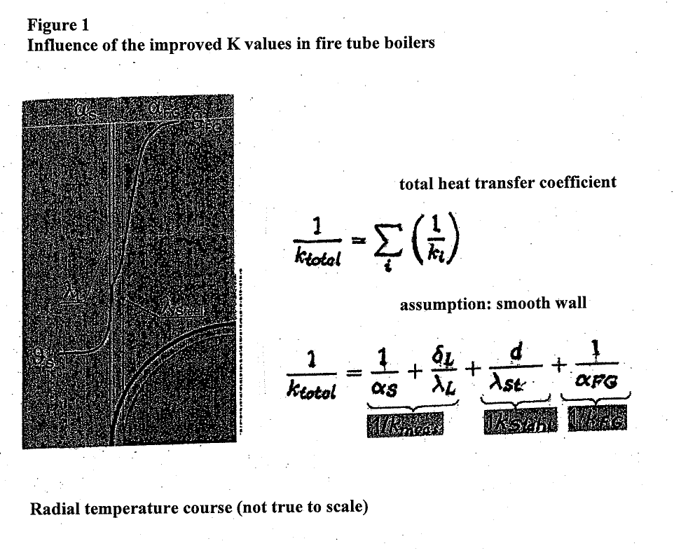

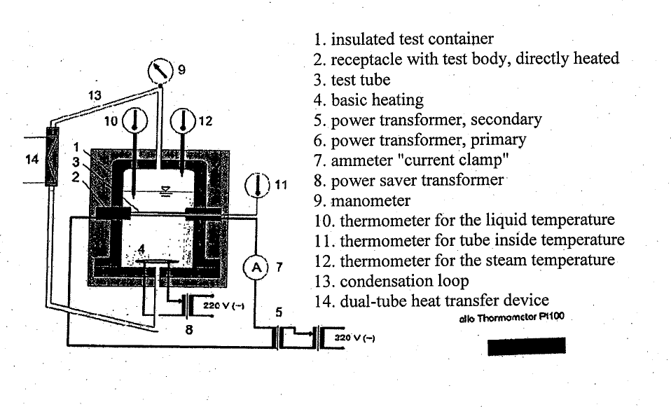

In the technical field of thermodynamics, the heat transfer coefficient or K-value is computed with the aid of the algorithm shown in FIG. 1.

The total value for the heat transfer coefficient is composed of different shares:

1) the heat transfer coefficient of combustion gas onto the tube (K_{FG});
2) the thermal conductivity of the tube (Kₛₜₑₑₗ) and
3) the heat transfer coefficient of the tube on the steam/water phase (Kₘₑₐₛ). See the following outline in this connection:

The inventors discovered a noticeable improvement of Kₘₑₐₛ on blank tubes—delta_{L}=0 (L is the thickness of the layer on the tube)—up to the thermally stationary condition of delta_{L}>0. Kₛₜₑₑₗ remained constant during the duration of the experiment. The tube and thus also the combustion gas (K_{FG}) are heated electrically and can therefore also be viewed as constant.

It should be emphasized here that the measured effect of the improvement for Kₘₑₐₛ cannot be traced back to the known, indirect improvement as a result of preventing inorganic deposits of components in the water, e.g. calcium carbonate. This was ensured by using fully de-salinized water for the feed water.

The invention is specified in greater detail below with the aid of the claims:

1. A medium for improving the heat transfer coefficient in steam generating plants, wherein this medium contains at least one film-forming amine (component a) with the general formula:

a. R—(NH—(CH₂)ₘ)ₙ—NH₂, wherein R is an aliphatic hydrocarbon radical with a chain length ranging from 12 to 22, m is a whole number between 1 and 8 and n is a whole number between 0 and 7, in amounts of up to 15%.

2. The medium according to claim 1 for improving the heat transfer coefficient in steam generating plants, characterized in that it also contains one or more components b to d in addition to the film-forming amine:

b. One or more alkalizing amino alkanols with the formula ZO—Z′—NR′R″, wherein Z and Z′ represent a C1-C6 linear or branched alkyl group or hydrogen and can be identical or different and wherein R′ and R″ represent a C1-C4- alkyl group or hydrogen and can be identical or different, in amounts of up to 50%.

c. One or more dispersing agents, in an amount of up to 5 weight %, which are selected from compounds having the general structural formula,

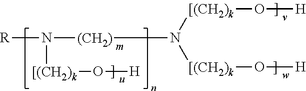

wherein R represents an aliphatic alkyl group with a chain length of C₆ to C₂₂, k represents a number between 2 and 3, and the parameters u, v, and w represent whole numbers, wherein the sum of v+w+(nu) ranges between 2 and 22 and/or a compound with the formula R³—C—O—((CH₂)ₒ—O—)ₚ—Z′, wherein R³ represents an aliphatic alkyl group (saturated or unsaturated) with a chain length between C₆ and C₂₂, Z′ is defined as above, o is a whole number between 1 and 4 (boundaries included), p represents a whole number between 2 and 22 (boundaries included).

d. Water to supplement up to 100 weight %.

3. The medium according to claim 1, characterized in that the compound octadecenylpropane-1,3-diamine in amounts of 0.5 to 5 weight % is preferably used as the film-forming amine (component a).
4. The medium according to claim 1, characterized in that ammonia and/or cyclohexylamine and/or morpholine and/or diehtylaminoethanol and/or aminomethylpropanol are used as component b, preferably in amounts of up to 30%.
5. The medium according to claim 1, characterized in that the compound ethoxylated talcum-amine is used as component c in 15 to 20 EO units, preferably in amounts of 0.5 to 1 weight %.
6. The use of the medium according to claims 1 to 5, as a medium for improving the heat transfer in steam generating plants, characterized in that the concentration of the film-forming amine (component a) in the condensate ranges from 0.05 to 2 ppm and preferably from 0.1 to 1 ppm.

The model apparatus and/or the measuring equipment, shown schematically in FIG. 1 and specially designed for measuring the heat transfer, is not the subject matter of the invention.

### Realizing the Experiment:

A specially designed test arrangement, used for examining the heat transfer during the container boiling, allowed the experimental determination of the heat transfer coefficient k and the characterization of surface effects since the boiling behavior of the experimental heating surfaces is decisively influenced by their (micro) geometric features (thickness, porosity/roughness).

The measurement was designed to determine the pressure-dependent and time-dependent characteristic boiling curves of conditioned boiler systems in dependence on the impressed heat flux density q on the experimental scale. It was furthermore the goal of these experiments to demonstrate the quite surprising suitability of the medium according to the invention as compared to the medium used according to the prior art.

The test arrangement for simulating the conditions near the boiler consists of two hermetically separated, identical pressure vessels, thus making it possible to simultaneously carry out the testing of two different water treatments.

A tube heating surface, installed in the apparatus so as to be submerged below the exposed water surface, generates saturated steam with the appropriate state of saturation. This replaceable, cold-drawn precision steel tube with dimensions of (6×1) mm, which is inserted process-tight, is heated directly with resistance heating via a high-power transformer and the power supply lines. FIG. 1 schematically shows the total experimental configuration.

### Pre-treatment of the Tubes

To ensure the highest possible reproducibility of the individual experiment, the tube samples are chemically cleaned and activated following the soldering into the power supply. This operation takes place using a clean pickling or scouring solution which removes surface oxidation products as well as impurities, acquired by the precision tubes through contact during the production, storage or transport of these tubes. The treatment is realized as follows:

1. removal of organic impurities with acetone;
2. activation of the tube surface with a pickling or scouring solution (25% HCl, 5% HNO₃, VE (demineralized) water) by submerging it for an interval of 6 minutes;
3. flushing with tap water (1-2 minutes);
4. neutralizing with 10% soda solution and submerging;
5. flushing with VE water (1-2 minutes);
6. flushing with isopropanol and subsequent drying at 105° C. in the drying cabinet (for 20 minutes).

The dried boiling tube is then photographed and is inserted in the hot condition—electrically insulated against the test vessel—into this vessel. The electrical lines are installed, the sensor for the tube inside temperature (insulated with a ceramic tube) is positioned in such a way that it is located geometrically in the center of the tube and the container is filled with the conditioned water (approx. 4.2 1).

### Test Program

The test program comprises the following points during the long-term treatment at a saturation pressure of pₛ=15bar and recurring determination of the heat transfer coefficient at different pressure stages (2, 15bar).

1. Reference treatment of blank metal tubes with sodium phosphate up to the steady-state for the oxide layer, demonstrated with measuring technology.
2. Treatment of blank metal sample bodies with inventive medium (EGM) up to the steady-state.
3. Change in the treatment from sodium phosphate to EGM, continued treatment with the organic product up to the demonstrated steady-state for the heat flux coefficient.

The initial conditioning for the reference treatment with sodium phosphate and the subsequent operations with the inventive medium (EGM) are summarized in the following Table 1.

The EGM material contains the following components for this experiment:

a. 2 weight % of oleyl propylene diamine

b. 7 weight % of cyclohexylamine

c. 18 weight % of monoethanolamine

d. 0.5 weight % of non-ionized tenside

e. residual water to 100%.

The inventive medium, however, is not restricted to this composition which only represents an exemplary variant.

TABLE 1
properties of boiler water at the start of the water treatment.

| | | pH value of | pH value of | |
|---|---|---|---|---|
| conditioning | concentration | boiler water | condensate | conductance in |
| medium | in ppm | (25° C.) | (25° C.) c | mS/cm |
| Na₃PO₄ | 15-25 | 10.0-10.5 | 7-7.5 | 100-140 |
| inventive | 0.5-1.0 | >8 | >9 | 60-80 |
| medium | | | | |

### Guaranteeing the Operating Conditions

To guarantee the conditions in the boiler as listed in Table 1, the concentration of applied boiler additives is determined regularly, so as to meter in additional additives and/or to dilute a concentration that is too high.

With an inorganic operation, the pH value of the boiler water is viewed as control variable which should be in the range of 10.0≦pH≦10.5. Since the pH value in the batch operation is determined discontinuously, the adaptation to the desired value is also discontinuous. In the process, a volume of approx. 1 liter boiler water is removed following the sample taking (approx. 50 ml) if the value drops below the lower pH limit, which is then replaced with a correspondingly conditioned equivalent and is subsequently degased several times. Should the pH value be sufficient, no further measures are taken, so that as little influence as possible is exerted on the oxide layer formation.

The substitution of a small volume of water ensures that the test tube body remains permanently submerged below the exposed water level. Since the batch operation entails a concentration of steam components that are not volatile during the treatment period and which are only conditionally removed during the aforementioned water substitution, this results in part in higher phosphate contents (up to 50 ppm) and electrical conductivities (up to 180 mS/cm) at the end of the operational period of up to r=1000h.

During the water treatment with the inventive medium, the concentration of the free film-forming amine (FA) in the condensate serves as benchmark, wherein respectively one sample is removed from the liquid and the condensate for determining it. A calibrated photometric test provides information on the amount of film-forming amine contained therein. If the actual value falls below the desired value window of 0.5 ppm≦[fA]≦1.0 ppm, an adjustment is made by adding formula via a N₂ overpressure metering system. For higher volumes, a metering pump can be used, if applicable. Depending on the measured concentration in the boiler, up to 230 μl formula is subsequently metered in. A substitution of water identical to the one for the phosphate operation does not take place in this case.

Should an excess be detected, this also countered by substituting a water volume of 1 liter (VE).

The system loses water and/or especially water vapor and thus volatile steam components as a result of unavoidable leakages at the valve seats and tube connections. The make-up dose is thus configured such that following the adaptation, the upper limit value (approx. 1 ppm) of the film-forming amine is briefly reached in the condensate. The average of the aforementioned concentration range can be maintained at all times through regular monitoring.

### Data Logging

Up to nine thermal flux densities are measured for each pressure stage in order to create a boiling characteristic.

Owing to the heat transfer into the boiler water, a certain non-stationarity of the operating point results for low and/or high thermal flux densities. That is to say, with high saturation pressures and correspondingly high heat losses and a small thermal flux density, the saturation temperature is subject to a negative trend. The reverse case applies for low saturation pressures and high thermal flux densities. This phenomenon is countered by using the auxiliary heating unit (only in the nucleate boiling range).

A further measure involves the “passing through” the actual operating point as a result of the cooling/heating of the system. A subsequent averaging of the measuring values (which have a maximum temperature deviation of 0.5° K for the desired saturation temperature) ensures the further processing of representative measuring values.

The aforementioned averaging and correction of the systematic measuring errors for the temperature and/or the current measurement takes place—in the same way as the determination of the heat transfer coefficient - using an electronic evaluation routine under Matlab®.

TABLE 2
(prior art)

| | | Pₛ = 2 bar | | pₛ = 15 bar | |
|---|---|---|---|---|---|
| | treatment | heat flux | heat transfer | heat flux | heat transfer |
| | period | density in | coefficient | density in | coefficient |
| treatment | in h | W/m² | in W/m² K) | W/m² | in W/m² K) |
| Na₃PO₄ | 0 | 40000 | 5419.0 | 40000 | 11634.6 |
| | | 50000 | 6418.3 | 50000 | 13401.4 |
| | | 60000 | 7370.2 | 60000 | 15042.3 |
| | | 70000 | 8284.4 | 70000 | 16585.6 |
| | | 80000 | 9167.4 | 80000 | 18049.8 |
| | | 80000 | 10024.1 | 80000 | 19448.3 |
| | | 100000 | 10858.1 | 100000 | 20790.8 |
| | | 200000 | 18368.9 | 200000 | 32254.8 |
| | | 300000 | 24983.3 | 300000 | 41702.3 |
| | | 400000 | 31075.3 | 400000 | 50040.0 |
| | | 500000 | 36806.3 | 500000 | 57638.9 |
| | | 600000 | 42265.0 | 600000 | 64696.8 |
| | 300 | 40000 | 4141.9 | 40000 | 8039.5 |
| | | 50000 | 4905.6 | 50000 | 9260.4 |
| | | 60000 | 5633.2 | 60000 | 10394.3 |
| | | 70000 | 6331.9 | 70000 | 11460.7 |
| | | 80000 | 7006.8 | 80000 | 12472.5 |
| | | 90000 | 7661.6 | 90000 | 13438.9 |
| | | 100000 | 8299.0 | 100000 | 1436.6 |
| | | 200000 | 14039.7 | 200000 | 22288.2 |
| | | 300000 | 19095.1 | 300000 | 28816.5 |
| | | 400000 | 23751.4 | 400000 | 34577.9 |
| | | 500000 | 28131.6 | 500000 | 39828.8 |
| | | 600000 | 32303.8 | 600000 | 44705.8 |

TABLE 3
invention

| | | Pₛ = 2 bar | | pₛ = 15 bar | |
|---|---|---|---|---|---|
| | treatment | heat flux | heat transfer | heat flux | heat transfer |
| | period | density in | coefficient | density in | coefficient |
| treatment | in h | W/m² | in W/m² K) | W/m² | in W/m² K) |
| EGM | 0 | 40000 | 5254.0 | 40000 | 23994.3 |
| | | 50000 | 8575.0 | 50000 | 26754.4 |
| | | 60000 | 9830.9 | 60000 | 29243.7 |
| | | 70000 | 11035.3 | 70000 | 31528.3 |
| | | 80000 | 12197.2 | 80000 | 33651.1 |
| | | 90000 | 13323.2 | 90000 | 35641.8 |
| | | 100000 | 14418.3 | 100000 | 37522.2 |
| | | 200000 | 24243.4 | 200000 | 52623.7 |
| | | 300000 | 32855.6 | 300000 | 64136.9 |
| | | 400000 | 40763.9 | 400000 | 73803.0 |
| | | 500000 | 48186.8 | 500000 | 82293.1 |
| | | 600000 | 55244.7 | 600000 | 89950.0 |
| | 300 | 40000 | 5913.8 | 40000 | 18695.8 |
| | | 50000 | 6990.7 | 50000 | 20846.5 |
| | | 60000 | 8014.6 | 60000 | 22786.2 |
| | | 70000 | 8996.5 | 70000 | 24566.3 |
| | | 80000 | 9943.8 | 80000 | 26220.3 |
| | | 90000 | 10861.7 | 90000 | 27771.4 |
| | | 100000 | 11754.5 | 100000 | 29236.6 |
| | | 200000 | 19764.4 | 200000 | 41003.4 |
| | | 300000 | 26785.5 | 300000 | 4997.3 |
| | | 400000 | 33232.7 | 400000 | 57506.0 |
| | | 500000 | 39284.3 | 500000 | 64121.2 |
| | | 600000 | 45038.1 | 600000 | 70087.4 |

Tables 2 and 3 show the results of the tests performed with the prior art products and the inventive product (EGM). It is immediately obvious that the heat transfer coefficient W/m² is clearly improved and/or increased as compared to the product according to the prior art. That is to say, the higher the coefficient, the better the transfer of heat.

The effect of the improvement in the heat transfer coefficient with EGM is also maintained if the tubes are initially treated as disclosed in the prior art (Na₃PO₄) until the thermal stationarity is reached and the EGM is subsequently used for the conditioning.

TABLE 4

| | | Pₛ = 2 bar | | ps = 15 bar | |
|---|---|---|---|---|---|
| | treatment | heat flux | heat transfer | heat flux | heat transfer |
| treatment | period | density in | coefficient | density in | coefficient |
| with | in h | W/m² | in W/m² K) | W/m² | in W/m² K) |
| EGM after | 0 | 40000 | 6187.0 | 40000 | 18995.4 |
| Na3PO4 | | 50000 | 7176.6 | 50000 | 1895.4 |
| | | 60000 | 8101.5 | 60000 | 20750.5 |
| | | 70000 | 8975.9 | 70000 | 22360.3 |
| | | 80000 | 9809.3 | 80000 | 23855.4 |
| | | 90000 | 10608.4 | 90000 | 25257.0 |
| | | 100000 | 11378.2 | 100000 | 26580.4 |
| | | 200000 | 18039.8 | 200000 | 37194.0 |
| | | 300000 | 23622.0 | 300000 | 45271.6 |
| | | 400000 | 28601.6 | 400000 | 52045.7 |
| | | 500000 | 33176.2 | 500000 | 57990.7 |
| | | 600000 | 37452.0 | 600000 | 63348.8 |
| | 450 | 40000 | 5599.2 | 40000 | 14549.2 |
| | | 50000 | 6494.7 | 50000 | 16211.1 |
| | | 60000 | 7331.8 | 60000 | 17708.9 |
| | | 70000 | 8123.1 | 70000 | 19082.8 |
| | | 80000 | 8877.3 | 80000 | 20358.8 |
| | | 90000 | 9600.5 | 90000 | 21554.9 |
| | | 100000 | 10297.2 | 100000 | 22684.3 |
| | | 200000 | 16325.9 | 200000 | 31742.2 |
| | | 300000 | 21377.7 | 300000 | 38635.8 |
| | | 400000 | 25884.2 | 400000 | 44417.0 |
| | | 500000 | 30024.1 | 500000 | 49490.6 |
| | | 600000 | 33893.7 | 600000 | 54063.3 |

1. A medium for improving the heat transfer coefficient in steam generating plants, said medium comprising at least one film-forming amine (component a) in amounts of up to 15% with the general formula:
a. R—(NH—(CH₂)ₘ)ₙ—NH₂, wherein R is an aliphatic hydrocarbon radical with a chain length of between 12 and 22, m is a whole number between 1 and 8 and n is a whole number between 0 and 7.

2. The medium according to claim 1 for improving the heat transfer coefficient in steam generating plants, characterized in that it contains one or several components b to d in addition to the film-forming amine:
b. one or several alkalizing aminoalkanols with the formula ZO—Z′—NR′R″ in amounts of up to 50%, wherein Z and Z′ represent a C₁-C₆ straight-chain or branched alkyl group or hydrogen and can be identical or different, and wherein R′ and R″ represent a C₁-C₄ alkyl group or hydrogen and can be identical or different.
c. one or several dispersing agents selected from compounds with the general structural formula 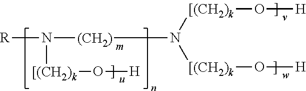
and in amounts of 5 weight %,
wherein R is an aliphatic alkyl group with a chain length of C₆ to C₂₂, k represents a number between 2 and 3, the parameters u, v and w represent whole numbers, wherein the sum of v+w+(nu) is between 2 and 22 and/or compounds with the formula R³—C—O—((CH₂)ₒ—O—)ₚ—Z′, wherein R³ represents an aliphatic alkyl group (saturated or unsaturated) with a chain length between C₆ and C₂₂ and Z′ is defined as shown in the above, o represents a whole number between 1 and 4 including the boundaries, p represents a whole number between 2 and 22 including the boundaries.
d. water to make up the difference to 100 weight %.

3. The medium according to claim 1, characterized in that the compound octadecenyl propane-1,3-diamine in amounts of 0.5 to 5 weight % is used for the film-forming amine (component a).

4. The medium according to claim 2, characterized in that ammonia and/or cyclohexylamine and/or morpholine and/or diethylaminoethanol and/or aminomethylpropanol is used for the component b.

5. The medium according to claim 2, characterized in that 15 to 20 EO units of ethoxylated talcum amine are used for component c.

6. A method for improving heat transfer in steam generating plants, comprising adding the medium according to the claim 1
wherein the concentration of the film-forming amine (component a) in a condensate is 0.05 to 2 ppm, preferably 0.1 to 1 ppm.

7. The medium according to claim 4, wherein component b is used in an amount up to 30%.

8. The medium according to claim 5, where component c is used in an amount of 0.5 to 1 weight %.

9. The method according to claim 6, wherein the medium further comprises one or several components b to d in addition to the film-forming amine:
b. one or several alkalizing aminoalkanols with the formula ZO—Z′—NR′R″ in amounts of up to 50%, wherein Z and Z′ represent a C₁-C₆ straight-chain or branched alkyl group or hydrogen and can be identical or different, and wherein R′ and R″ represent a C₁-C₄ alkyl group or hydrogen and can be identical or different.
c. one or several dispersing agents selected from compounds with the general structural formula 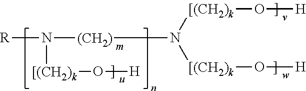
and in amounts of 5 weight %,
wherein R is an aliphatic alkyl group with a chain length of C₆ to C₂₂, k represents a number between 2 and 3, the parameters u, v and w represent whole numbers, wherein the sum of v+w+(nu) is between 2 and 22 and/or compounds with the formula R³—C—O—((CH₂)₀—O—)ₚ—Z′, wherein R³ represents an aliphatic alkyl group (saturated or unsaturated) with a chain length between C₆ and C₂₂ and Z′ is defined as shown in the above, o represents a whole number between 1 and 4 including the boundaries, p represents a whole number between 2 and 22 including the boundaries.
d. water to make up the difference to 100 weight %.
